(19) United States
(12) Patent Application Publication
(10) Pub. No.: US 2018/0210988 A1
(43) Pub. Date: Jul. 26, 2018

(54) CIRCUIT DELAY ANALYZING APPARATUS, CIRCUIT DELAY ANALYZING METHOD, AND NON-TRANSITORY COMPUTER-READABLE RECORDING MEDIUM

(71) Applicant: FUJITSU LIMITED, Kawasaki-shi (JP)

(72) Inventor: Masashi Arayama, Gamagori (JP)

(73) Assignee: FUJITSU LIMITED, Kawasaki-shi (JP)

(21) Appl. No.: 15/874,128

(22) Filed: Jan. 18, 2018

(30) Foreign Application Priority Data
Jan. 23, 2017 (JP) 2017-009139

(51) Int. Cl. G06F 17/50

(52) U.S. Cl. CPC G06F 17/5031; G06F 2217/84; G06F 17/5036; G06F 17/5068

(57) ABSTRACT

A circuit delay analyzing apparatus that analyzes a delay in a circuit including a plurality of transistors, and a first resistor coupled in a path commonly extended between a power source and the plurality of transistors, the circuit delay analyzing apparatus includes, a memory includes net list of the circuit, and a processor coupled to the memory, configured to read the net list and select first transistors from the plurality of transistors that are coupled to the path, produce a partial circuit that includes the first resister and the first transistors, delete the first register; add first copy resisters reproduced from the first resistor to the partial circuit; and analyze the delay in the partial circuit.

### CROSS-REFERENCE TO RELATED APPLICATION

This application is based upon and claims the benefit of priority of the prior Japanese Patent Application No. 2017-009139, filed on Jan. 23, 2017, the entire contents of which are incorporated herein by reference.

### FIELD

The embodiment discussed herein is related to a circuit delay analyzing apparatus, a circuit delay analyzing method, and a non-transitory computer-readable recording medium.

### BACKGROUND

Custom macro circuits higher in performance than those in the related art are used to develop processors today. The custom macro circuit is a functional block that includes a cell including one or more transistors laid out and wired in a semiconductor circuit. The custom macro circuits have been increased in terms of the operation speed and the degree of complication, and have become larger in scale. It is thus difficult to analyze a time delay in the entire circuit.

Techniques available to perform a circuit delay analysis include a method of partitioning a whole circuit into partial circuits, and a method of simplifying a circuit.

In another technique available, a net list is divided into unit blocks, a circuit block of a specific scale is formed by combining the unit blocks under a specific condition, and a dynamic timing analysis is performed on each circuit block. A simulation technique to approximate an output load is also available.

As the degree of complication of each circuit is increased, transistors sharing a power source resistor are included in the circuit. As each circuit is miniaturized, the shape of each element forming the circuit varies. To control the variations in the shape of the elements, an element that works as a dummy (dummy element) may be laid out close to an element of interest.

The delay analyzing method of related art suffers from a trade-off between an analysis accuracy of delay time and processing time of a circuit including a dummy circuit or transistors sharing a power source resistor.

The followings are reference documents.
[Document 1] Japanese Laid-open Patent Publication No. 2002-215710,
[Document 2] Japanese Laid-open Patent Publication No. 2006-146595,
[Document 3] Japanese Laid-open Patent Publication No. 3-252770,
[Document 4] Japanese Laid-open Patent Publication No. 2000-331043, and
[Document 5] Japanese Laid-open Patent Publication No. 2014-182430.

### SUMMARY

According to an aspect of the invention, a circuit delay analyzing apparatus that analyzes a delay in a circuit including a plurality of transistors, and a first resistor coupled in a path commonly extended between a power source and the plurality of transistors, the circuit delay analyzing apparatus includes, a memory includes net list of the circuit, and a processor coupled to the memory, configured to read the net list and select first transistors from the plurality of transistors that are coupled to the path, produce a partial circuit that includes the first resister and the first transistors, delete the first register; add first copy resisters reproduced from the first resistor to the partial circuit; and analyze the delay in the partial circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a circuit including transistors that do not share a power source resistor;

FIG. 2 is a schematic diagram of a circuit including transistors that share a power source resistor;

FIG. 3 is a schematic diagram of a circuit that includes dummy transistors;

FIG. 4 illustrates a configuration of a circuit delay analyzing apparatus of an embodiment;

FIG. 5 is a flowchart illustrating a circuit delay analyzing method of the embodiment;

FIG. 6 is a flowchart illustrating a circuit partitioning process in detail;

FIG. 7A is a detailed flowchart illustrating a reproducing process of a power source resistor network;

FIG. 7B is a detailed flowchart illustrating a reproducing process of a power source resistor network;

FIG. 8 is a schematic diagram of a circuit that serves as a target of the reproducing process of the power source resistor network;

FIG. 9 is a schematic diagram of a circuit with a power source resistor network removed therefrom;

FIG. 10 is a schematic diagram of a circuit in which a power source resistor network is reproduced;

FIG. 11 is a schematic diagram of a circuit with an undesired resistor removed therefrom;

FIG. 12 is a detailed flowchart illustrating of a dummy transistor reproducing process;

FIG. 13 is a schematic diagram of a circuit that serves as a target of the dummy transistor reproducing process;

FIG. 14 is a schematic diagram of circuits with dummy transistors removed therefrom;

FIG. 15 is a schematic diagram of circuits with dummy transistors reproduced therewithin; and

FIG. 16 illustrates a configuration of an information processing apparatus (computer).

### DESCRIPTION OF EMBODIMENT

Problems associated with the delay analyzing method of related art are described first.

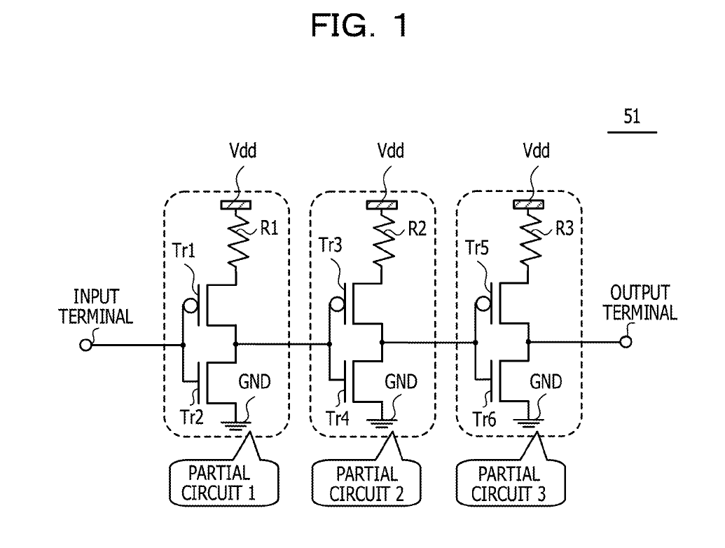

FIG. 1 is a schematic diagram of a circuit including transistors that do not share a power source resistor.

A circuit 51 of FIG. 1 includes resistors R1 through R3, transistors Tr1 through Tr6, a power source Vdd, and ground GND. The resistors R1 through R3 respectively connected between transistors Tr1, Tr3, and Tr5 and the power source Vdd are also represented by power source resistors R1 through R3. A set of the power source resistors is referred to as a power source resistor network. The circuit 51 is an example of a custom macro circuit serving as an analysis target or an example of a circuit (processor) that includes the custom macro circuit. The circuit 51 is a one-input and one-output circuit.

The transistors Tr1, Tr3, and Tr5 are p-channel metal oxide-semiconductor field effect transistors (pMOS transistors), and the transistors Tr2, Tr4, and Tr6 are n-channel MOS transistors. A combination of transistors Tr1 and Tr2, a combination of transistors Tr3 and Tr4, and a combination of transistors Tr5 and Tr6 respectively form inverter circuits.

The input terminal of the circuit 51 is connected to the gates of the transistors Tr1 and Tr2. The sources of the transistors Tr1, Tr3, and Tr5 are respectively connected to the power source resistors R1, R2, and R3. The drains of the sources of the transistors Tr1, Tr3, and Tr5 are respectively connected to the drains of the transistors Tr2, Tr4, and Tr6. The sources of the transistors Tr2, Tr4, and Tr6 are connected to the ground GND.

The drain of the transistor Tr1 and the drain of the transistor Tr2 are connected together with the gates of the transistors Tr3 and Tr4. The drain of the transistor Tr3 and the drain of the transistor Tr4 are connected together with the gates of the transistors Tr5 and Tr6. The drain of the transistor Tr5 and the drain of the transistor Tr6 are connected together with the output terminal of the circuit 51.

The circuit 51 of FIG. 1 is partitioned into three partial circuits. The partial circuits 1 through 3 respectively include two transistors. The circuit including transistors not sharing power source resistors may be reduced in circuit scale, leading to a shorter analysis time.

Circuits may include transistors sharing power source resistors as a result of a complicated power source resistor network.

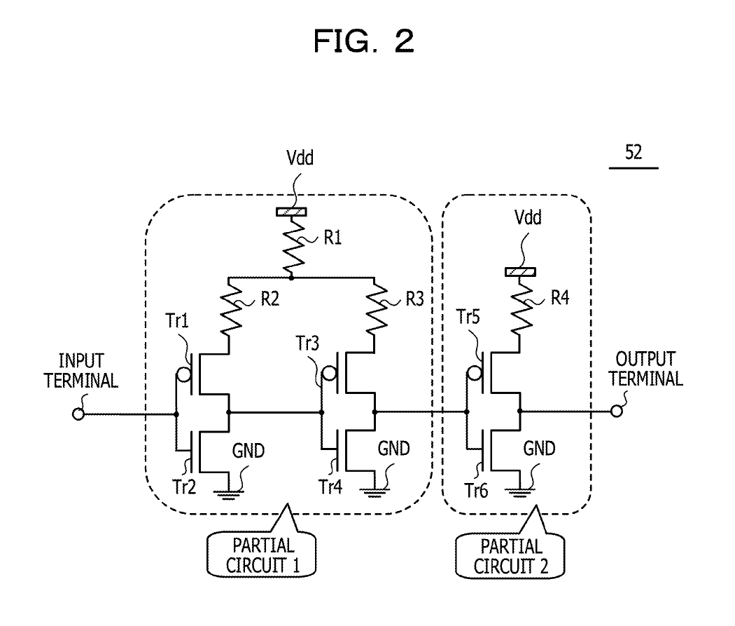

FIG. 2 is a schematic diagram of a circuit 52 including transistors that share a power source resistor.

The circuit 52 of FIG. 2 includes resistors R1 through R4, transistors Tr1 through Tr6, a power source Vdd, and a ground GND. The resistors R1 through R4 connected between the sources of the transistors Tr1, Tr3, and Tr5 and the power source Vdd are also referred to as power source resistors R1 through R4. The circuit 52 is as an analysis target an example of a custom macro circuit or an example of a circuit (processor) including the custom macro circuit. The circuit 52 has a one-input and one-output circuit.

The transistors Tr1, Tr3, and Tr5 are pMOS transistors, and the transistors Tr2, Tr4, and Tr6 are nMOS transistors. A combination of transistors Tr1 and Tr2, a combination of transistors Tr3 and Tr4, and a combination of transistors Tr5 and Tr6 respectively form inverter circuits.

The input terminal of the circuit 52 is connected to the gates of the transistors Tr1 and Tr2. The sources of the transistors Tr1, Tr3, and Tr5 are respectively connected to the power source resistors R2, R3, and R4. The power source resistors R2 and R3 are connected to the power source resistor R1. The power source resistors R1 and R4 are connected to the power source Vdd. The drains of the transistors Tr1, Tr3, and Tr5 are respectively connected to the drains of the transistors Tr2, Tr4, and Tr6. The sources of the transistors Tr2, Tr4, and Tr6 are respectively connected to the ground GND.

The drain of the transistor Tr1 and the drain of the transistor Tr2 are connected together with the gates of the transistors Tr3 and Tr4. The drain of the transistor Tr3 and the drain of the transistor Tr4 are connected together with the gates of the transistors Tr5 and Tr6. The drain of the transistor Tr5 and the drain of the transistor Tr6 are connected together with the output terminal of the circuit 52.

Referring to FIG. 2, the transistor Tr1 is connected to the power source Vdd via the power source resistors R1 and R2. The transistor Tr3 is connected to the power source Vdd via the power source resistors R1 and R3.

The transistor Tr1 and the transistor Tr3 have a common path with the power source Vdd and thus share the power source resistor R1 connected in the common path. The transistors that share the power source resistor in this way are difficult to analyze by partitioning, and are desirably to be analyze at a time. Since the transistors Tr1 through Tr4 connected via source-drain connection, they are difficult to partition. Since the drains of the transistors Tr3 and Tr4 are connected together with the gates of the transistors Tr5 and Tr6, the transistors Tr3 and Tr4 may be partitioned from the transistors Tr5 and Tr6. If the circuit 52 is partitioned into partial circuits, partial circuits 1 and 2 result.

The partial circuit 1 includes four transistors, namely, transistors Tr1 through Tr4. The analysis time exponentially increases as the number of transistors increases. If there are transistors that share a power source, it is difficult to partition the circuit. The number of transistors included in a single circuit increases, and the analysis time becomes longer.

As a circuit is miniaturized, the shape of each element, such a transistor forming the circuit, varies. To reduce variations in the element shape caused by optical proximity effect, a transistor that functions as a dummy (dummy transistor) is typically disposed close to a target element. The dummy transistor does not allow a signal to pass therethrough, and does not affect an input and output logic in the circuit (more specifically, elements such as transistors) when a delay caused by the dummy transistor is not accounted for. The dummy transistor is an example of a dummy element. A dummy element other than a dummy transistor may be used if the dummy element does not affect the input and output logic of the circuit. A transistor connected to the dummy transistor is difficult to analyze by partitioning, and is desirably analyzed at a time.

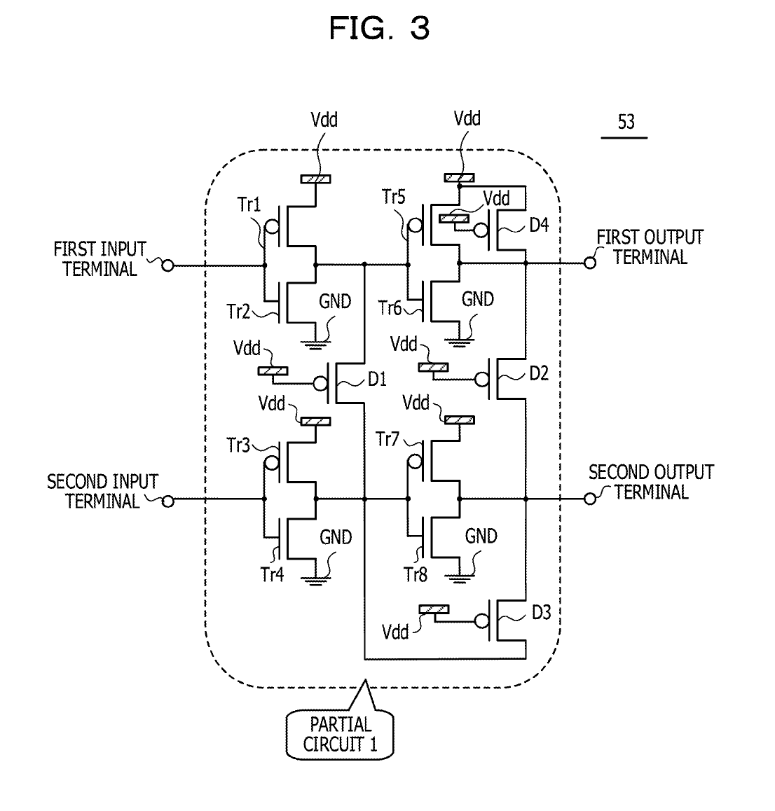

FIG. 3 is a schematic diagram of a circuit 53 that includes dummy transistors.

The circuit 53 of FIG. 3 includes transistors Tr1 through Tr8, dummy transistors D1 through D4, a power source Vdd, and a ground GND. The circuit 53 is as an analysis target an example of a custom macro circuit or an example of a circuit (processor) including the custom macro circuit. The circuit 53 has a two-input and two-output circuit.

The transistors Tr1, Tr3, Tr5, and Tr7, and the dummy transistors D1 through D4 are pMOS transistors, and the transistors Tr2, Tr4, Tr6, and Tr8 are nMOS transistors. A combination of transistors Tr1 and Tr2, a combination of transistors Tr3 and Tr4, a combination of transistors Tr5 and Tr6, and a combination of transistors Tr7 and Tr8 respectively form inverter circuits.

A first input terminal of the circuit 53 is connected together to the gates of the transistors Tr1 and Tr2. A second input terminal of the circuit 53 is connected together to the gates of the transistors Tr3 and Tr4. The sources of the transistors Tr1, Tr3, Tr5, and Tr7 are respectively connected to the power source Vdd. The drains of the transistors Tr1, Tr3, Tr5, and Tr7 respectively connected to the drains of the transistors Tr2, Tr4, Tr6, and Tr8. The sources of the transistors Tr2, Tr4, Tr6, and Tr8 are respectively connected to the ground GND.

The drain of the transistor Tr1 and the drain of the transistor Tr2 are connected together with the gates of the transistors Tr5 and Tr6. The drain of the transistor Tr3 and the drain of the transistor Tr4 are connected together with the gates of the transistors Tr7 and Tr8. The drain of the transistor Tr5 and the drain of the transistor Tr6 are connected together with a first output terminal of the circuit 52. The drain of the transistor Tr7 and the drain of the transistor Tr8 are connected together with a second output terminal of the circuit 52.

The gates of the dummy transistors D1 through D4 are respectively connected to the power source Vdd. The source of the dummy transistor D1 is connected to the drains of the transistors Tr1 and Tr2 and the gates of the transistors Tr5 and Tr6. The drain of the dummy transistor D1 is connected to the drains of the transistors Tr3 and Tr4 and the gates of the transistors Tr7 and Tr8. When no delay through the dummy transistor D1 is accounted for with no signal applied thereto, the dummy transistor D1 does not affect the output logic of the transistors Tr1 and Tr2, and the input logic of the transistors Tr5 and Tr6.

The source of the dummy transistor D2 is connected to the drains of the transistors Tr5 and Tr6, the first output terminal, and the drain of the dummy transistor D4. The drain of the dummy transistor D2 is connected to the drains of the transistors Tr7 and Tr8, the second output terminal, and the source of the dummy transistor D3. When no delay through the dummy transistor D2 is accounted for with no signal applied thereto, the dummy transistor D2 does not affect the output logic of the transistors Tr5 through Tr8.

The source of the dummy transistor D3 is connected to the drains of the transistors Tr7 and Tr8, the second output terminal, and the drain of the dummy transistor D2. The drain of the dummy transistor D3 is connected to the drains of the transistors Tr3 and Tr4, and the drain of the dummy transistor D1. When no delay through the dummy transistor D3 is accounted for with no signal applied thereto, the dummy transistor D3 does not affect the output logic of the transistors Tr3, Tr4, Tr7, and Tr8.

The source of the dummy transistor D4 is connected to the source of the transistor Tr5 and the power source Vdd. The drain of the dummy transistor D4 is connected to the drains of the transistors Tr5 and Tr6, the first output terminal, and the source of the dummy transistor D2. When no delay through the dummy transistor D4 is accounted for with no signal applied, the dummy transistor D4 does affect the output logic of the transistors Tr5 and Tr6.

Since the transistors Tr1 through Tr8 are connected via the dummy transistors D1 through D4 in the circuit 53 of FIG. 3, it is difficult to analyze the circuit 53 through partitioning the circuit 53 into partial circuits. The circuit 53 including the eight transistors Tr1 through Tr8 and the four dummy transistors D1 through D4 is analyzed at a time, and the processing time becomes longer.

The presence of the dummy transistors increases the number of transistors that are to be analyzed at a time, exponentially increasing the processing time.

The power source resistor network and the dummy transistors may be removed from the circuit, and the circuit with the power source resistor network and the dummy transistors removed therefrom may be partitioned into partial circuits. The scale of each partial circuit (in other words, the number of transistors included in each partial circuit) is thus reduced, and the processing time is decreased. In comparison with an actual circuit, the analysis results of the circuit with the power source resistor network and the dummy transistors removed therefrom are not sufficiently accurate. Sufficient analysis accuracy is difficult to obtain without accounting for the power source resistor network and the dummy transistors.

The delay analysis method of related art has a trade-off between the analysis accuracy of the delay time and the processing time.

The embodiment is described below with reference to the drawings.

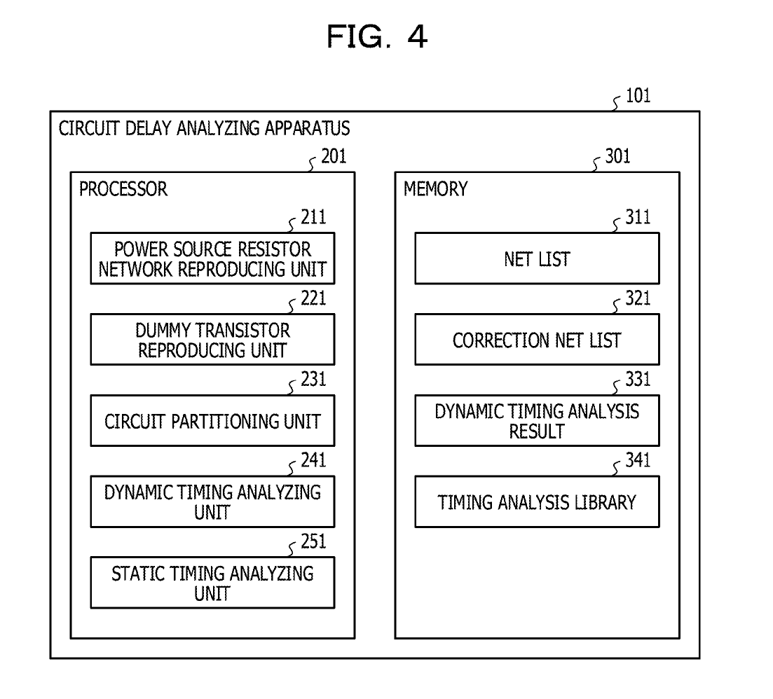

FIG. 4 illustrates a configuration of a circuit delay analyzing apparatus 101 of the embodiment.

The circuit delay analyzing apparatus 101 includes a processor 201 and a memory 301.

The processor 201 includes a power source resistor network reproducing unit 211, a dummy transistor reproducing unit 221, a circuit partitioning unit 231, a dynamic timing analyzing unit 241, and a static timing analyzing unit 251. Note that the circuit delay analyzing apparatus 101 may include only one of the power source resistor network reproducing unit 211 and the dummy transistor reproducing unit 221.

The power source resistor network reproducing unit 211 performs a reproducing process of a power source resistor network, thereby creating a circuit in which a power source resistor shared by multiple transistors is reproduced.

The dummy transistor reproducing unit 221 performs a dummy transistor reproducing process, thereby creating a circuit in which a dummy transistor is reproduced.

The circuit partitioning unit 231 partitions a target circuit into multiple partial circuits.

The dynamic timing analyzing unit 241 performs a dynamic timing analysis. The dynamic timing analyzing unit 241 performs simulations on each of the partial circuits in view of a delay time, thereby measuring a propagation time of a signal. The dynamic timing analyzing unit 241 stores on the memory 301 the results of the dynamic timing analysis as a dynamic timing analyzing result 331.

The static timing analyzing unit 251 performs a static timing analysis, thereby analyzing the delay time of a signal. More in detail, the static timing analyzing unit 251 calculates the delay time, based on the dynamic timing analyzing result 331. The static timing analyzing unit 251 stores on the memory 301 the results of the static timing analysis as a timing analysis library 341.

The memory 301 is a storage device that stores data used by the circuit delay analyzing apparatus 101. The memory 301 includes net list 311, correction net list 321, dynamic timing analyzing result 331, and timing analysis library 341.

The net list 311 is a net list of a custom macro circuit serving as an analysis target and a circuit including the custom macro circuit. The net list includes connection information related to a connection between terminals included in the circuit.

The correction net list 321 is a net list of circuits that have undergone at least one of the power supply resistor network reproducing process and the dummy transistor reproducing process.

The dynamic timing analyzing result 331 is the results of the dynamic timing analysis.

The timing analysis library 341 is the results of the static timing analysis.

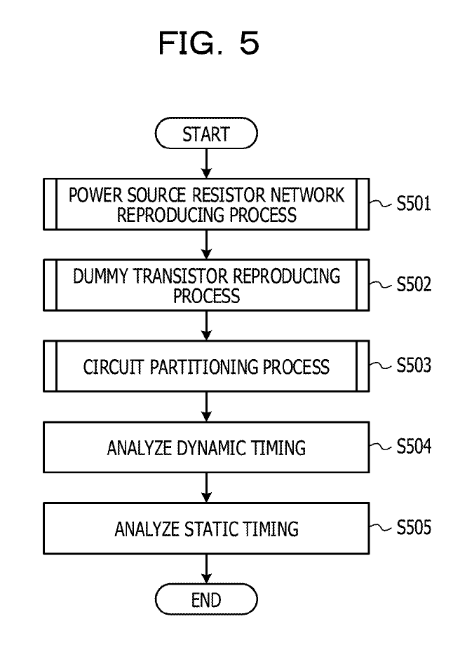

FIG. 5 is a flowchart illustrating a circuit delay analyzing method of the embodiment.

In step S501, the power source resistor network reproducing unit 211 performs the power supply resistor network reproducing process. The power supply resistor network reproducing process is described in detail below.

In step S502, the dummy transistor reproducing unit 221 performs the dummy transistor reproducing process. The dummy transistor reproducing process is described in detail below.

One of steps S501 and S502 may be possibly omitted.

In step S503, the circuit partitioning unit 231 performs circuit partitioning using the correction net list 321. The circuit partitioning unit 231 thus partitions into multiple partial circuits a circuit that has undergone at least one of the power supply resistor network reproducing process and the dummy transistor reproducing process. The circuit partitioning process is described in detail below.

In step S504, the dynamic timing analyzing unit 241 performs on each of the partial circuits produced in step S503 a simulation in view of the delay time, thereby measuring the propagation time of the signal. The dynamic timing analyzing unit 241 stores on the memory 301 the results of the dynamic timing analysis as the dynamic timing analysis result 331.

In step S505, the static timing analyzing unit 251 performs the static timing analysis, based on the dynamic timing analysis result 331, and stores on the memory 301 the results of the static timing analysis as the timing analysis library 341.

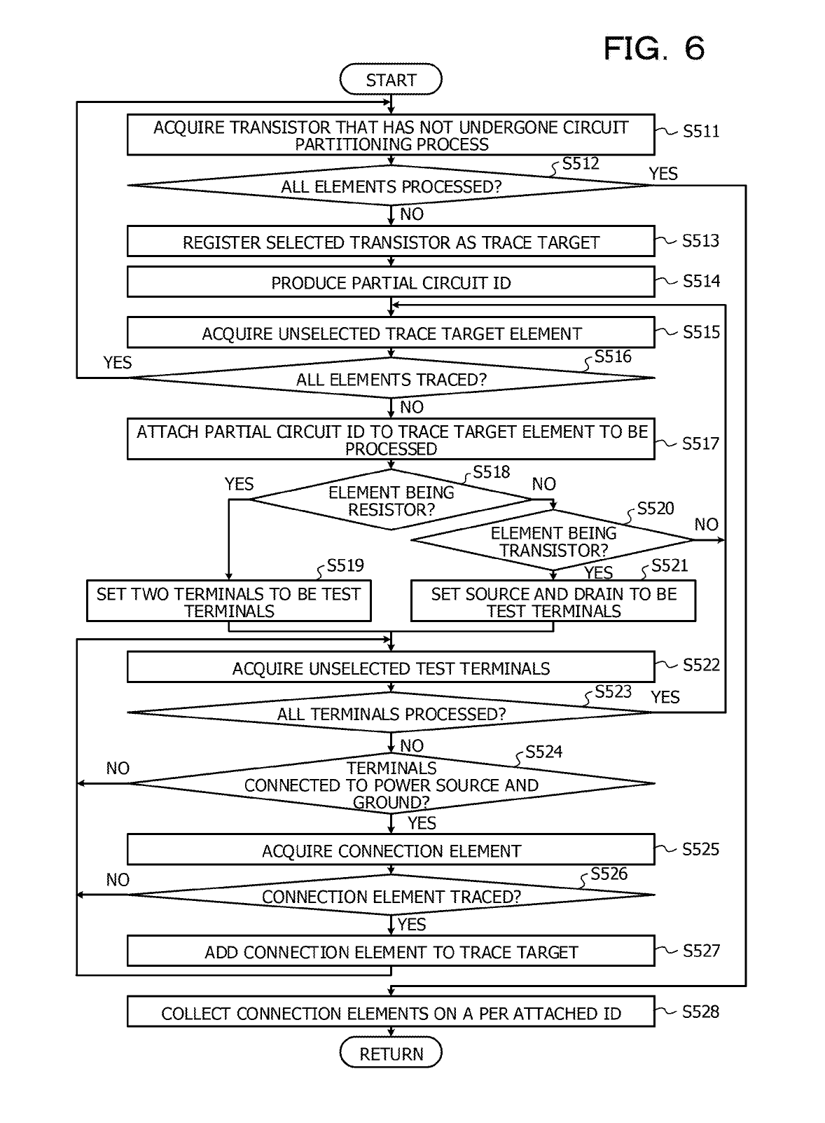

FIG. 6 is a flowchart illustrating the circuit partitioning process in detail.

The circuit partitioning process of FIG. 6 corresponds to step S503 of FIG. 5. The circuit partitioning process is performed in each of the power supply resistor network reproducing process and dummy transistor reproducing process described below.

In step S511, the circuit partitioning unit 231 selects a transistor that has not undergone the circuit partitioning process (namely, a transistor with a partial ID not yet attached thereto) in a circuit that is a target of the circuit partitioning process. If the circuit partitioning process is to be performed on a circuit that has undergone the power supply resistor network reproducing process and the dummy transistor reproducing process, the circuit partitioning unit 231 reads the correction net list 321, and acquires information concerning the circuit. In order to perform the circuit partitioning process in the power supply resistor network reproducing process, the circuit partitioning unit 231 acquires information concerning the circuit serving as the target of the circuit partitioning process from the power source resistor network reproducing unit 211. In order to perform the dummy transistor reproducing process in the dummy transistor reproducing process, the circuit partitioning unit 231 acquires the information concerning the circuit serving as the target of the circuit partitioning process from the dummy transistor reproducing unit 221. If there is no transistor that has undergone the circuit partitioning process, the circuit partitioning unit 231 proceeds to step S512 without performing any operation.

In step S512, the circuit partitioning unit 231 determines whether the circuit partitioning unit 231 has partitioned all the elements in the circuit as the target of the circuit partitioning process (in other words, all the elements are tagged with a partial circuit ID). If all the elements have been processed, control proceeds to step S528. If any element has not been processed, control proceeds to step S513.

In step S513, the circuit partitioning unit 231 adds the selected transistor as a trace target.

In step S514, the circuit partitioning unit 231 produces a partial circuit ID. The partial circuit ID is different from a partial circuit ID previously produced. For example, let the partial circuit ID produced at the n-th time be the partial circuit ID=n. The partial circuit ID previously produced is updated with the currently produced partial circuit ID.

In step S515, the circuit partitioning unit 231 selects an element, which is still unselected, from among the elements as the trace targets. The selected element is hereinafter referred to as a process target element.

In step S516, the circuit partitioning unit 231 determines whether the trace target elements hare traced (selected). If all the trace target elements are traced (selected), control returns to step S511. If any trace target element is not traced (selected), control proceeds to step S517.

In step S517, the circuit partitioning unit 231 attaches a partial circuit ID to a process target element.

In step S518, the circuit partitioning unit 231 determines whether the process target element is a resistor.

In step S519, the circuit partitioning unit 231 sets both terminals (two terminals) of the resistor to be test terminals.

In step S520, the circuit partitioning unit 231 determines whether the process target element is a transistor. If the process target element is a transistor, control proceeds to step S521, and if the process target element is not a transistor, control returns to step S515.

In step S521, the circuit partitioning unit 231 sets the terminal connected to the source of the transistor and the terminal connected to the drain of the transistor to be test terminals.

In step S522, the circuit partitioning unit 231 selects an unselected terminal of the test terminals. The selected terminal is hereinafter referred to as a process target terminal.

In step S523, the circuit partitioning unit 231 determines whether all the test terminals as the process target elements have been processed (selected). If all the test terminals as the process target elements have been processed (selected), control returns to step S515. If any test terminal has not been processed (selected), control proceeds to step S524.

In step S524, the circuit partitioning unit 231 determines whether the process target terminal is connected to the power source or the ground. If the process target terminal is connected to the power source or the ground, control returns to step S522. If the process target terminal is not connected to the power source or the ground, control proceeds to step S525.

In step S525, the circuit partitioning unit 231 acquires (detects) an element (connection element) connected to the process target terminal.

In step S526, the circuit partitioning unit 231 determines whether the connection element has been traced. If the connection element has been traced, control returns to step S522. If the connection element has not been traced, control proceeds to step S527. If the connection element is included as a trace target, the circuit partitioning unit 231 determines that the connection element has been traced. If the connection element is not included as a trace target, the circuit partitioning unit 231 determines that the connection element has not been traced.

In step S527, the circuit partitioning unit 231 adds the connection element as a trace target.

In step S528, the circuit partitioning unit 231 collects elements in a partial circuit according to each ID attached thereto. By collecting the elements having the same ID attached thereto in the same partial circuit, the circuit partitioning unit 231 produces multiple partial circuits.

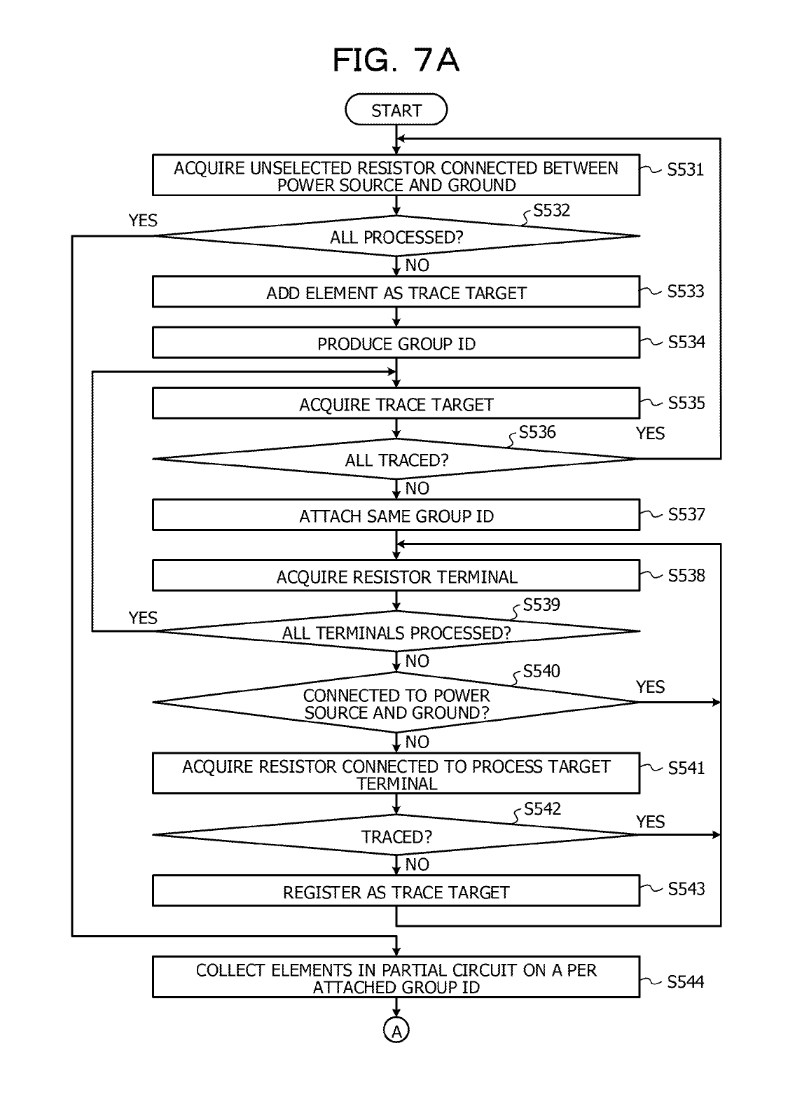

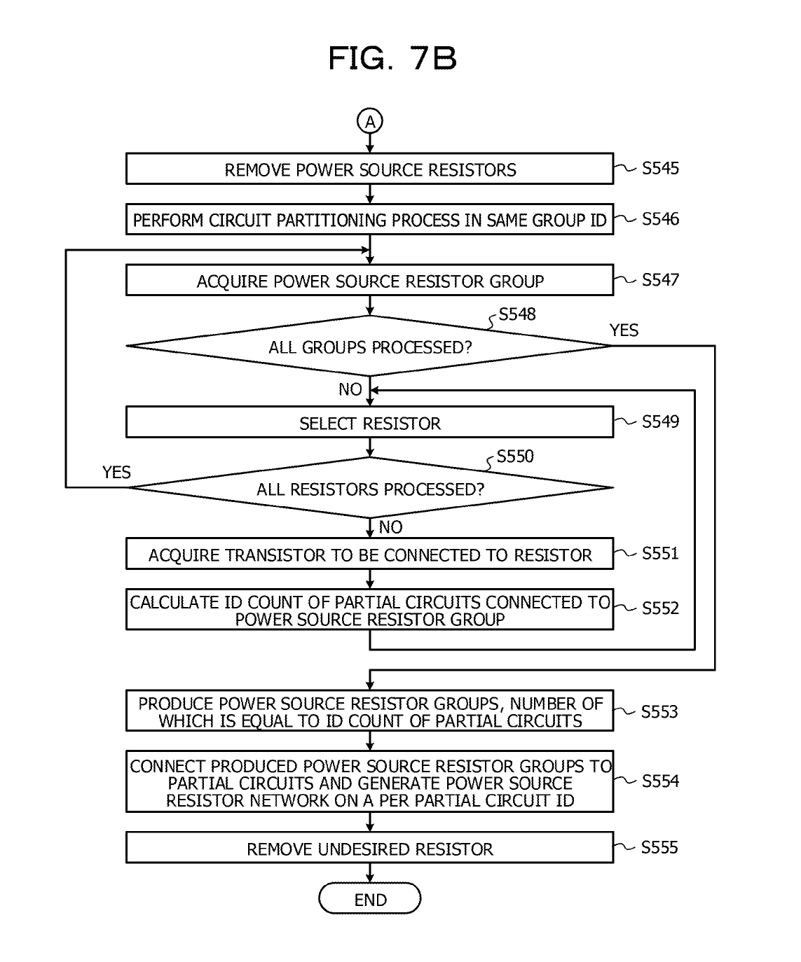

FIG. 7A and FIG. 7B are detailed flowcharts of the power supply resistor network reproducing process.

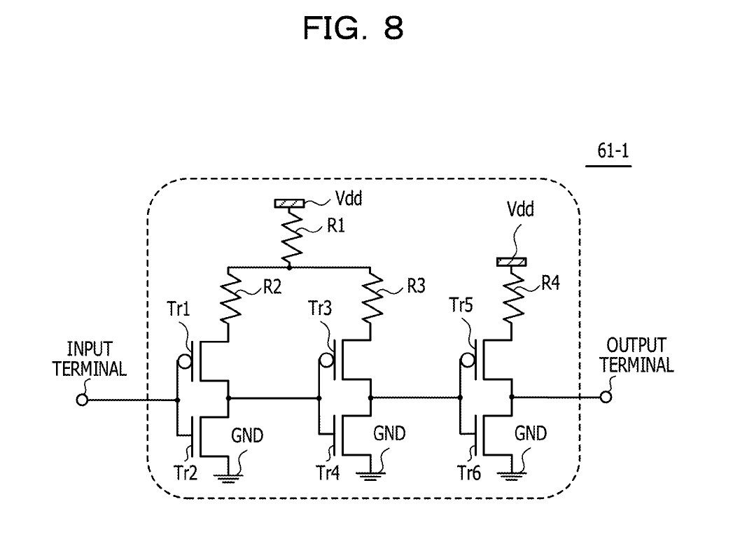

A circuit 61-1 of FIG. 8 is processed herein. The circuit 61-1 is as a process target an example of a custom macro circuit serving or an example of a circuit including the custom macro circuit. The circuit 61-1 is identical in configuration to the circuit 52 of FIG. 2, and the detailed discussion thereof is omitted herein. The circuit 61-1 is an example of an analysis target, and may further include a dummy transistor.

In step S531, the power source resistor network reproducing unit 211 reads the net list 311 of the circuit as an analysis target, and selects a resistor (connection resistor) connected to the power source or the ground in the circuit that is a target of the power supply resistor network reproducing process.

In step S532, the power source resistor network reproducing unit 211 determines whether all the elements in the circuit have been processed (tagged with the group ID). If all the elements have been processed, control proceeds to step S544. If any element has not been processed, control proceeds to step S533.

In step S533, the power source resistor network reproducing unit 211 adds the resistor selected in step S531 as a trace target.

In step S534, the power source resistor network reproducing unit 211 produces a group ID. The group ID is different from a group ID previously produced. For example, let the group ID produced at the n-th time be the group ID=n. The group ID previously produced is updated with the currently produced group ID.

In step S535, the power source resistor network reproducing unit 211 selects a still unselected element from among the trace target elements. The selected element is hereinafter referred to as a process target element.

In step S536, the power source resistor network reproducing unit 211 determines whether all the trace target elements have been traced (selected). If all the trace target elements have been traced (selected), control returns to step S531. If any trace target element has not been traced (selected), control proceeds to step S537.

In step S537, the power source resistor network reproducing unit 211 attaches a group ID to the process target element. The group ID is the latest group ID.

In step S538, the power source resistor network reproducing unit 211 selects an unselected terminal of the two terminals of the process target element. The selected terminal is hereinafter referred to as a process target terminal.

In step S539, the power source resistor network reproducing unit 211 determines whether both terminals of each of the process target elements have been processed. If both terminals of each of the process target elements have been processed, control returns to step S535. If any terminal of each of the process target elements has not been processed, control proceeds to step S540.

In step S540, the power source resistor network reproducing unit 211 determines whether the process target terminal is connected to the power supply or the ground. If the process target terminal is connected to the power supply or the ground, control returns to step S538. If the process target terminal is connected to none of the power supply and the ground, control proceeds to step S541.

In step S541, the power source resistor network reproducing unit 211 acquires a resistor (connection resistor) connected to the process target terminal.

In step S542, the power source resistor network reproducing unit 211 determines whether the connection resistor has been traced (tagged with the group ID). If the connection resistor has been traced, control returns to step S538. If the connection resistor has not been traced, control proceeds to step S543.

In step S543, the power source resistor network reproducing unit 211 registers the connection resistor as a trace target.

In step S544, the power source resistor network reproducing unit 211 collects the elements in a partial circuit according to the group ID. More in detail, the power source resistor network reproducing unit 211 performs the following operations (1) through (6).

(1) Multiple power source resistors having the same group ID attached thereto are selected from unselected power source resistors. The multiple power source resistors having the same group ID attached thereto are referred to as a power source resistor group. Referring to FIG. 8, resistors R1 through R3 are included in a first power source resistor group, and resistor R4 is included in a second power source resistor group.

(2) A transistor with the source or the drain thereof connected to the selected power source resistor is acquired.

(3) A transistor with the source or the drain thereof connected to the transistor acquired in operation (2) is acquired.

(4) If a new transistor is acquired in operation (3), operation (3) is performed on that transistor. Operations (3) and (4) are iterated.

(5) The same group ID as the group ID attached to the power source resistor selected in operation (1) is attached to the transistors acquired in operations (2) through (4).

(6) Operations (2) through (5) are iterated on all the power source resistor groups.

In step S544, a partial circuit including elements having the same group ID attached thereto is produced.

In the circuit 61-1 of FIG. 8, the same group ID is attached to the power source resistors R1 through R3, and the transistors Tr1 through Tr4.

In step S545, the power source resistor network reproducing unit 211 removes the power source resistors from the circuit. Referring to FIG. 7B, the power source resistor network reproducing unit 211 removes the power source resistors R1 through R4 from the circuit 61-1.

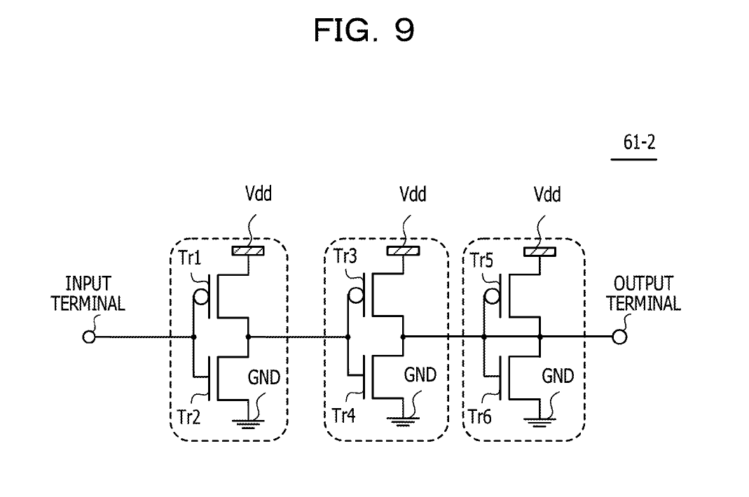

In step S546, the power source resistor network reproducing unit 211 performs the circuit partitioning process on each partial circuit including the elements having the same group ID attached thereto. The circuit partitioning process has been described with reference to FIG. 6. Through the circuit partitioning process, a circuit 61-2 of FIG. 9 is partitioned into three partial circuits 1 through 3.

In step S547, the power source resistor network reproducing unit 211 selects one of the unselected power source resistor groups. The selected power source resistor group is referred to as a process target power source resistor group.

In step S548, the power source resistor network reproducing unit 211 determines whether all the power source resistor groups have been processed (selected). If all the power source resistor groups have been processed (selected), control proceeds to step S553. If any power source resistor group has not been selected, control proceeds to step S549.

In step S549, the power source resistor network reproducing unit 211 selects a still unselected power source resistor from among the power source resistors included in the process target power source resistor group. The selected power source resistor is hereinafter referred to as a process target power source resistor.

In step S550, the power source resistor network reproducing unit 211 determines whether all power source resistors included in the process target power source resistor group have been processed. If all power source resistors included in the process target power source resistor group have been processed, control returns to step S547. If any power source resistor included in the process target power source resistor group has not been processed, control proceeds to step S551.

In step S551, the power source resistor network reproducing unit 211 acquires a transistor connected to the process target power source resistor.

In step S552, the power source resistor network reproducing unit 211 calculates the number of IDs of the partial circuits connected to the process target power source resistor group. Since the first power source resistor group including the power source resistors R1 through R3 is connected to two partial circuits 1 and 2, the number of IDs of the partial circuits connected to the first power source resistor group is 2. Since the second power source resistor group including the power source resistor R4 is connected to the partial circuit 3, the number of IDs of the partial circuits connected to the second power source resistor group is 1.

In step S553, the power source resistor network reproducing unit 211 reproduces copies of the power source resistor groups of the ID count of the partial circuits connected to each power source resistor group. Since the power source resistor group including the power source resistors R1, R2, and R3 is connected to two partial circuits 1 and 2, the power source resistor network reproducing unit 211 reproduces copies of two power source resistor groups. The first power source resistor group reproduced includes power source resistors R1′, R2′, and R3′, and the second power source resistor group reproduced includes R1″, R2″, and R3″. Since the power source resistor group including the power source resistor R4 is connected to the partial circuit 3, a single power source resistor group is reproduced.

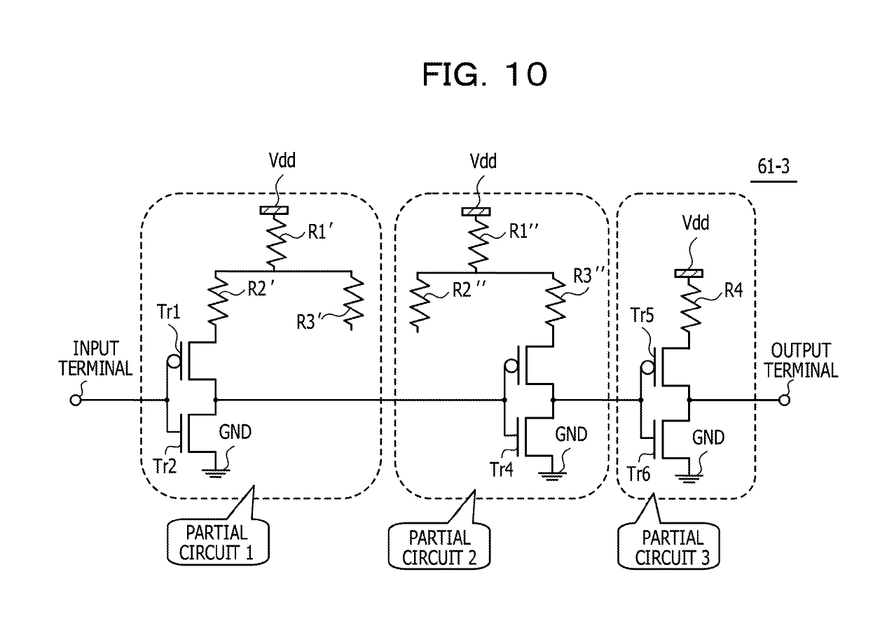

In step S554, the power source resistor network reproducing unit 211 reproduces a power source resistor network on a per partial circuit ID basis, by connecting the power source resistor group reproduced for each partial circuit. Referring to FIG. 9, the power source resistor network reproducing unit 211 connects the first power source resistor group including the reproduced power source resistors R1′, R2′, and R3′ to the partial circuit 1. The power source resistor network reproducing unit 211 connects the second power source resistor group including the reproduced power source resistors R1″, R2″, and R3″ to the partial circuit 2. The power source resistor group including the power source resistor R4 is connected to the partial circuit 3. In this way, the circuit 61-3 of FIG. 10 is created.

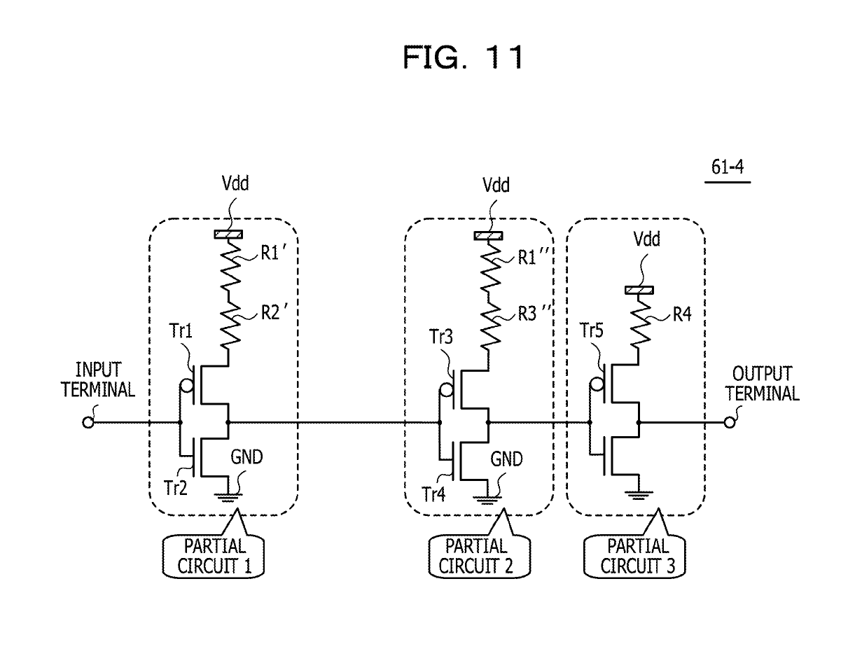

In step S555, the power source resistor network reproducing unit 211 removes an undesired resistor. The undesired resistor is a resistor with one of the terminals thereof remaining unconnected in an open state. Power source resistors R3′, and R2″, each having one terminal remaining unconnected in the circuit 61-3 as illustrated in FIG. 10, are thus undesired, and the power source resistor network reproducing unit 211 remove the power source resistors R3′, and R2″. A circuit 61-4 of FIG. 11 thus results. By removing the undesired resistors, the circuit is simplified, and the analysis time is shortened. In the circuit 61-1 of FIG. 8, the power source resistors R2 and R3 are disposed at locations not common in the paths between each of the transistors Tr1 and Tr3 and the power source Vdd. When the power source resistors R2 and R3 are reproduced and connected to each partial circuit, one terminal of each copy (the power supply resistors R3′ and R2″) is left open and thus removed.

The power source resistor network reproducing unit 211 outputs the net list of the corrected circuit 61-4 to the dummy transistor reproducing unit 221. The power source resistor network reproducing unit 211 may store on the memory 301 the net list of the corrected circuit 61-4 as the correction net list 321.

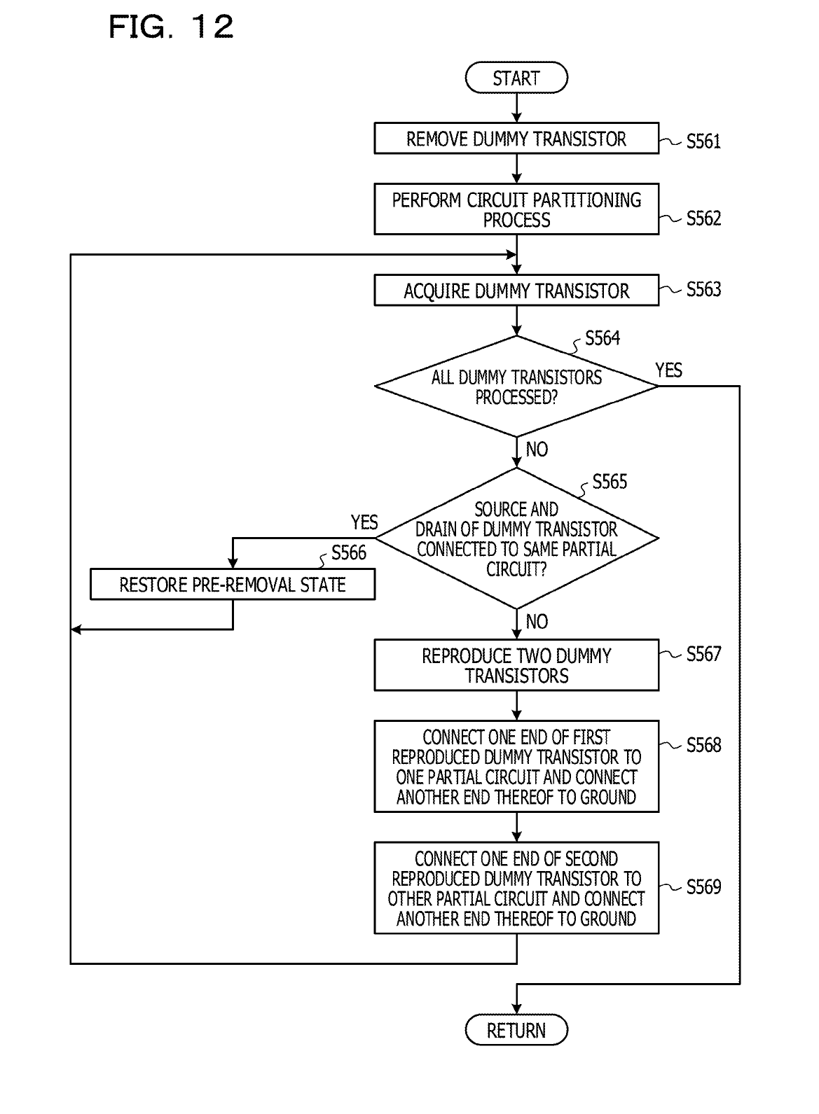

FIG. 12 is a detailed flowchart of the dummy transistor reproducing process.

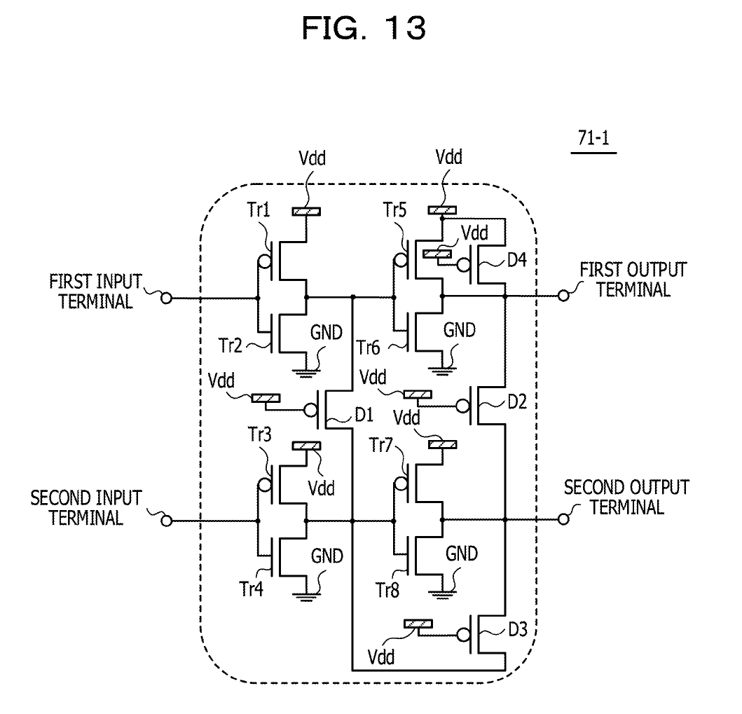

The process of a circuit 71-1 illustrated in FIG. 13 is described below. The circuit 71-1 is as an analysis target an example of a custom macro circuit or an example of a circuit including the custom macro circuit. The circuit 71-1 is identical in configuration to the circuit 53 of FIG. 3, and the detailed discussion thereof is omitted herein. For convenience of explanation, the circuit 71-1 is described. The circuit 71-1 is different from the circuit 61-1 that has been used to describe the power supply resistor network reproducing process. In a practical process, the dummy transistor reproducing process may be performed on a circuit including a power source resistor network that has been reproduced through the power supply resistor network reproducing process.

In step S561, the dummy transistor reproducing unit 221 removes a dummy transistor from a circuit that is a target of the dummy transistor reproducing process. The net list of the circuit indicates whether the transistor is a dummy transistor. By referencing the net list, the dummy transistor reproducing unit 221 identifies and then removes the dummy transistor. The dummy transistor reproducing unit 221 thus removes the dummy transistors D1 through D4 from the circuit 71-1. If the power supply resistor network reproducing process has been performed, the dummy transistor reproducing unit 221 receives from the power source resistor network reproducing unit 211 the information about the circuit (net list) which is a target of the dummy transistor reproducing process. If the power supply resistor network reproducing process has not been performed, the dummy transistor reproducing unit 221 reads from the memory 301 the net list 311 of the circuit that is the target of the dummy transistor reproducing process.

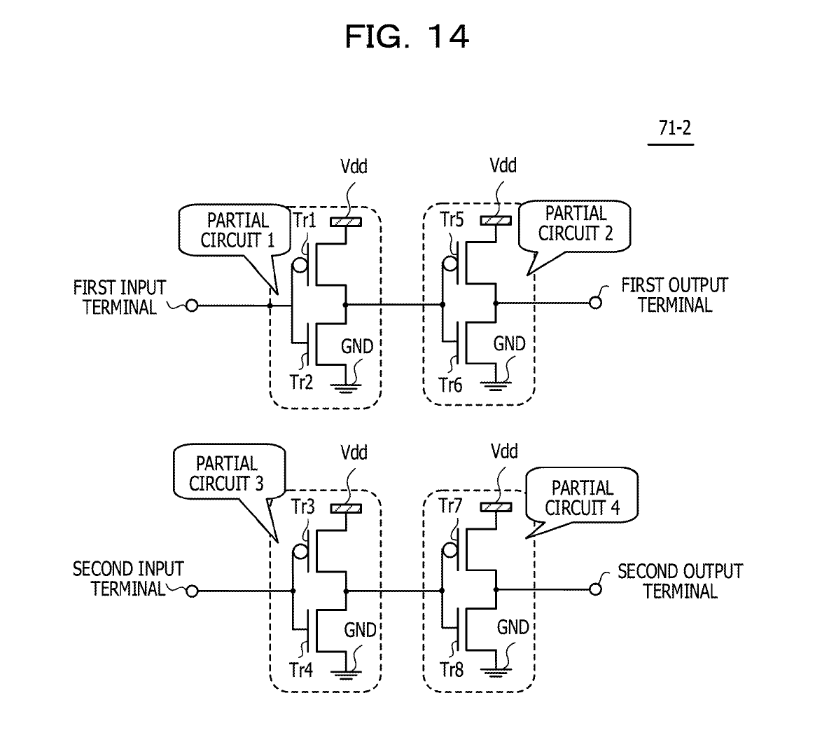

In step S562, the dummy transistor reproducing unit 221 performs the circuit partitioning process on the circuit with the dummy transistors removed. The circuit partitioning process has been described with reference to FIG. 6. Through the circuit partitioning process, a circuit 71-2 of FIG. 14 is partitioned into four partial circuits 1 through 4 as illustrated in FIG. 14.

In step S563, the dummy transistor reproducing unit 221 selects a still unselected dummy transistor out of the dummy transistors. The selected dummy transistor is referred to as a process target dummy transistor.

In step S564, the dummy transistor reproducing unit 221 determines whether all the dummy transistors have been processed. If all the dummy transistors have been processed, the process ends. If any of the dummy transistors has not been processed, control proceeds to step S565. If the operation in step S565 has been performed on all the dummy transistors, the dummy transistor reproducing unit 221 determines that all the dummy transistors have been processed.

In step S565, the dummy transistor reproducing unit 221 determines whether the source and drain of the process target dummy transistor are connected to the same partial circuit. If the source and drain of the process target dummy transistor are connected to the same partial circuit, control proceeds to step S566. If the source and drain of the process target dummy transistor are respectively connected to different partial circuits, control proceeds to step S567. If the process target dummy transistor is one of the dummy transistors D1 through D3, the dummy transistor reproducing unit 221 determines that the source and drain of the process target dummy transistor are respectively connected to different partial circuits. If the process target dummy transistor is the dummy transistor D4, the dummy transistor reproducing unit 221 determines that the source and drain of the process target dummy transistor are connected to the same partial circuit.

In step S566, the dummy transistor reproducing unit 221 restores the process target dummy transistor to a pre-removal state. More specifically, the dummy transistor reproducing unit 221 connects the process target dummy transistor to the original location in the partial circuit. Since the source and drain of the dummy transistor D4 are connected to the partial circuit 2, the dummy transistor reproducing unit 221 restores the dummy transistor D4 to the pre-removal state thereof, in other words, connects the dummy transistor D4 to the original location in the partial circuit 2.

In step S567, the dummy transistor reproducing unit 221 reproduces two copies of the process target dummy transistor. The dummy transistor reproducing unit 221 reproduces dummy transistors D1′ and D1″ as the copies of the dummy transistor D1. The dummy transistor reproducing unit 221 reproduces dummy transistors D2′ and D2″ as copies of the dummy transistor D2. The dummy transistor reproducing unit 221 reproduces dummy transistors D3′ and D3″ as copies of the dummy transistor D3.

In step S568, the dummy transistor reproducing unit 221 connects the first copy of the two copies to the original location in one of the different partial circuits to which the source and drain of the process target dummy transistor are respectively connected, and connects to the ground a terminal of the first copy that is not connected to the partial circuit. The dummy transistor reproducing unit 221 connects the dummy transistor D1′ to the original location in the partial circuit 1, and connects to the ground a terminal of the dummy transistor D1′ not connected to the partial circuit. The dummy transistor reproducing unit 221 connects the dummy transistor D2′ to the original location in the partial circuit 2, and connects to the ground a terminal of the dummy transistor D2′ not connected to the partial circuit. The dummy transistor reproducing unit 221 connects the dummy transistor D3′ to the original location in the partial circuit 4 and connects to the ground a terminal of the dummy transistor D3′ not connected to the partial circuit.

In step S569, the dummy transistor reproducing unit 221 connects the second copy of the two copies to the original location in the other of the different partial circuits to which the source and drain of the process target dummy transistor are respectively connected, and connects to the ground a terminal of the second copy that is not connected to the partial circuit. The dummy transistor reproducing unit 221 stores on the memory 301 the net list of the corrected circuit as the correction net list 321.

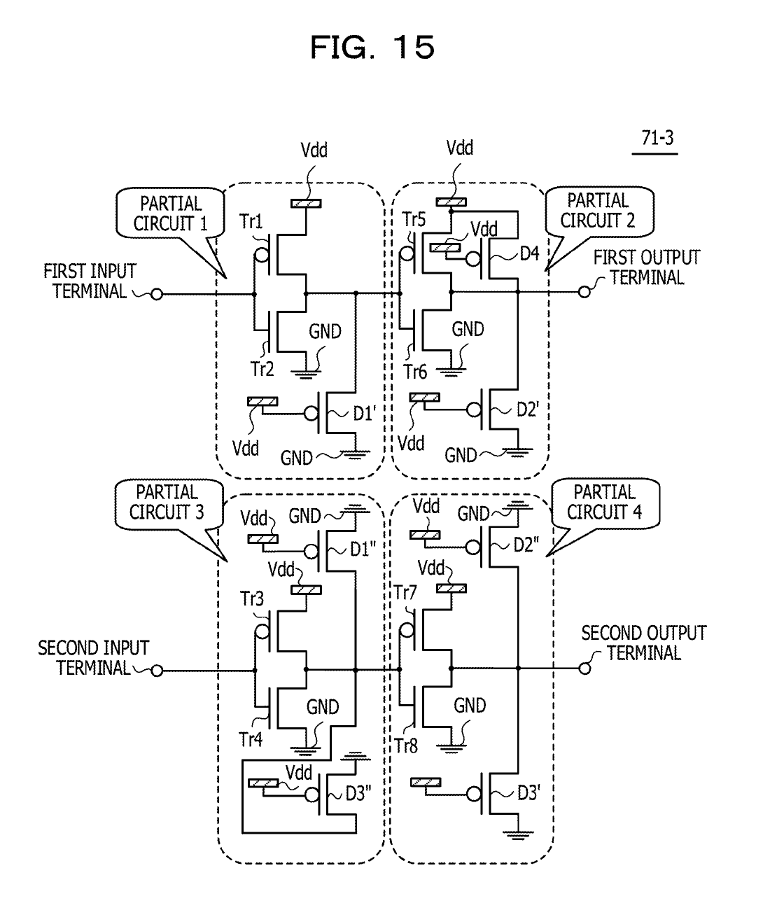

The dummy transistor reproducing unit 221 connects the dummy transistor D1″ to the original location in the partial circuit 2, and connects to the ground a terminal of the dummy transistor D1″ not connected to the partial circuit. The dummy transistor reproducing unit 221 connects the dummy transistor D2″ to the original location in the partial circuit 4, and connects to the ground a terminal of the dummy transistor D2″ not connected to the partial circuit. The dummy transistor reproducing unit 221 connects the dummy transistor D3″ to the original location in the partial circuit 3 and connects to the ground a terminal of the dummy transistor D3″ not connected to the partial circuit. In this way, a circuit 71-3 results as illustrated in FIG. 15. Through the above process, the scale of each partial circuit is reduced, and the effect of the dummy transistors is calculated on a per partial circuit basis.

The circuit delay analyzing apparatus of the embodiment thus shortens the analysis processing time of a delay time in a circuit including transistors or elements sharing a power source resistor.

The circuit delay analyzing apparatus of the embodiment determines a group ID of the power source resistor network in the same power source, and performs the delay analysis by separating, from the circuit, power source resistor networks, each corresponding to each of the partial circuit IDs within the same group ID. In accordance with the number of partial circuit IDs, the power source resistors are reproduced, thereby reducing the number of transistors in each partial circuit. The circuit delay analyzing apparatus thus balances processing time and accuracy.

The circuit delay analyzing apparatus of the embodiment performs the delay analysis by separating dummy transistors from a dummy transistor circuit. The circuit delay analyzing apparatus thus balances processing time and accuracy.

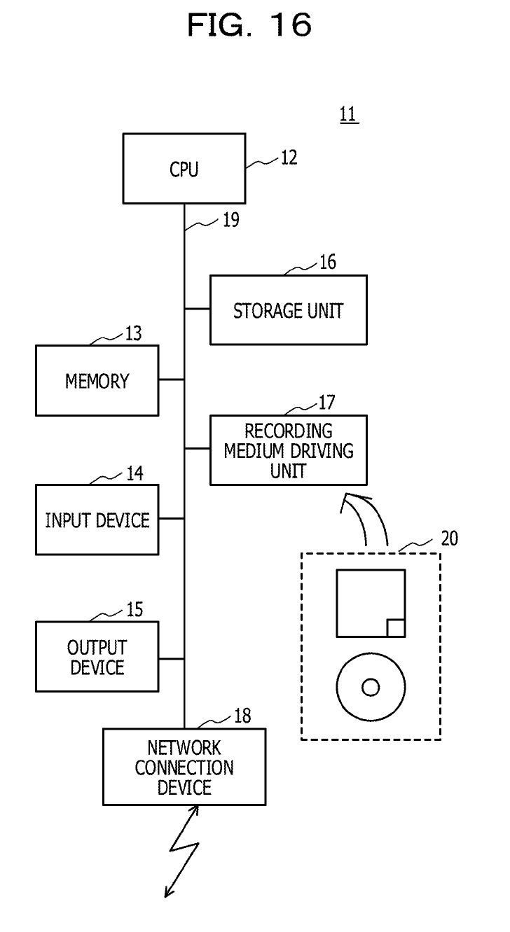

FIG. 16 illustrates a configuration of an image processing apparatus (computer) 11.

The circuit delay analyzing apparatus 101 of the embodiment is implemented by the information processing apparatus (computer) 11 of FIG. 16.

The image processing apparatus 11 includes a CPU 12, a memory 13, an input device 14, an output device 15, a storage unit 16, a recording medium driving unit 17, and a network connection device 18. These elements are interconnected via a bus 19.

The CPU 12 is a central processing unit that generally controls the image processing apparatus 11. The CPU 12 operates as the power source resistor network reproducing unit 211, the dummy transistor reproducing unit 221, the circuit partitioning unit 231, the dynamic timing analyzing unit 241, and the static timing analyzing unit 251.

The memory 13 may be a read-only memory (ROM) or a random-access memory (RAM), which temporarily stores a program and data stored on the storage unit 16 (or a portable recording medium 20). The CPU 12 performs the processes described above by executing the program with the memory 13.

The program code read from the portable recording medium 20 implements the functionality of the embodiment.

The input device 14 is used to receive a command and information input by a user or an operator, and to acquire data used by the image processing apparatus 11. The input device 14 may include a keyboard, a mouse, a touchpanel, a camera, and/or a sensor.

The output device 15, controlled by the CPU 12, outputs an enquiry or process results to the user or operator. The output device 15 may be a display or a printer.

The storage unit 16 may be a magnetic disk device, an optical disk device, or a tape device, for example. The image processing apparatus 11 may store the program and data on the storage unit 16, and read the program and data onto the memory 13 as appropriate for use. The memory 13 and the storage unit 16 correspond to the memory 301.

The recording medium driving unit 17 drives the portable recording medium 20, thereby accessing contents recorded thereon. The portable recording medium may include one of computer-readable recording media including a memory card, a flexible disk, a compact disk read-only memory (CD-ROM), an optical disk, and a magneto-optical disk. The user may pre-store the program and data on the portable recording medium 20, and read the program and data onto the memory 13 as appropriate for use.

The network connection device 18 is connected to any communication network, such as a local-area network (LAN), or a wide-area network (WAN), and performs data conversion in communications. The network connection device 18 transmits data to an apparatus connected thereto via the communication network, or receives data from an apparatus connected thereto via the communication network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A circuit delay analyzing apparatus that analyzes a delay in a circuit including a plurality of transistors, and a first resistor coupled in a path commonly extended between a power source and the plurality of transistors, the circuit delay analyzing apparatus comprising:
a memory includes net list of the circuit;
a processor coupled to the memory, configured to:
read the net list and select first transistors from the plurality of transistors that are coupled to the path;
produce a partial circuit that includes the first resister and the first transistors;
delete the first register;
add first copy resisters reproduced from the first resistor to the partial circuit; and
analyze the delay in the partial circuit.

2. The circuit delay analyzing apparatus according to claim 1,
wherein the circuit comprises a plurality of second resistors coupled in paths not commonly extended between the path and the plurality of transistors, and
wherein the processor is configured to
delete the second registers,
add second copy resisters reproduced from the second resistor to the partial circuit, and
remove from the partial circuits a copy of the second resistor with one terminal thereof being opened from among the copies of the second resistors.

3. A circuit delay analyzing apparatus that analyzes a delay in a circuit including a plurality of transistors, and a dummy element that does not affect an input and output logic of the transistors, the circuit delay analyzing apparatus comprising:
a memory includes net list of the circuit; and
a processor coupled to the memory, configured to:
add a copy reproduced from the dummy element to a partial circuit that contains a transistor coupled to the dummy element, from among partial circuits into which the circuit with the dummy element removed therefrom is partitioned; and
analyze a delay in the partial circuits with the copy of the dummy element added thereto.

4. The circuit delay analyzing apparatus according to claim 3, wherein the dummy element is a transistor, and
wherein the processor is configured to couple one terminal of the copy of the dummy element added to the partial circuit to ground.

5. A circuit delay analyzing method of analyzing a delay in a circuit including a plurality of transistors, and a first resistor coupled in a path commonly extended a power source and the transistors, the circuit delay analyzing method comprising causing a processor to execute the operation of:
removing the first resistor from the circuit;
partitioning the circuit with the first resistor removed therefrom into a plurality of partial circuits;
reproducing a copy of the first resistor;
adding the copy of the first resistor to each of the partial circuits; and
analyzing a delay of the partial circuits with the copies of the first resistor added thereto.

6. The circuit delay analyzing method according to claim 5, further comprising, with the circuit including a plurality of second resistors connected in paths not commonly extended between the power source and the transistors:
removing the second resistors from the circuit;
partitioning the circuit with the second resistors removed therefrom into a plurality of partial circuits;
reproducing copies of the second resistors;
adding respectively the second resistors to the partial circuits; and
removing from the partial circuits a second resistor with one terminal thereof opened from among the copies of the second resistors.

7. A non-transitory computer-readable recording medium that stores thereon a computer program causing a computer to execute a circuit delay analyzing process of analyzing a delay in a circuit including a plurality of transistors, and a first resistor connected in a path commonly extended between a power source and the transistors, the circuit delay analyzing process comprising:
removing the first resistor from the circuit;
partitioning the circuit with the first resistor removed therefrom into a plurality of partial circuits;
reproducing a copy of the first resistor;
adding the copy of the first resistor to each of the partial circuits; and
analyzing a delay of the partial circuits with the copy of the first resistor added thereto.

8. The non-transitory computer-readable recording medium according to claim 7, wherein the circuit delay analyzing process, with the circuit including a plurality of second resistors connected in paths not commonly extended between the power source and the transistors, comprises:
removing the second resistors from the circuit;
partitioning the circuit with the second resistors removed therefrom into a plurality of partial circuits;
reproducing copies of the second resistors;
adding respectively the second resistors to the partial circuits; and
removing from the partial circuits a second resistor with one terminal thereof opened from among the copies of the second resistors.
